(19) United States
(12) Patent Application Publication
(10) Pub. No.: US 2014/0030611 A1
(43) Pub. Date: Jan. 30, 2014

(54) METAL-AIR BUTTON CELLS AND THE PRODUCTION THEREOF

(71) Applicants: Edward Pytlik, Ellwangen (DE); Martin Krebs, Rosenberg (DE)

(72) Inventors: Edward Pytlik, Ellwangen (DE); Martin Krebs, Rosenberg (DE)

(73) Assignee: VARTA Microbattery GmbH, Ellwangen (DE)

(21) Appl. No.: 14/110,728

(22) PCT Filed: Apr. 3, 2012
(86) PCT No.: PCT/EP2012/056072

§ 371 Date: Oct. 9, 2013

(30) Foreign Application Priority Data
Apr. 13, 2011 (DE) 10 2011 007 295.0

(51) Int. Cl. H01M 12/06; H01M 12/08

(52) U.S. Cl. CPC H01M 12/06; H01M 12/08
USPC 429/403; 429/535

(57) ABSTRACT

A method of producing a metal-air button cell including a housing, an air cathode, a metal-based anode and a separator arranged in the housing, the method including printing the air cathode in the form of a planar layer onto a planar substrate by a screen printing process, wherein a paste including a solvent and/or suspending agent, particles made of an electro-catalytically active material, and binder particles made of a hydrophobic plastic material is used for printing, and inserting the laminar composite structure obtained during printing and which includes the planar substrate and the air cathode applied thereto into the housing and combined with the metal-based anode, wherein the planar substrate, onto which the air cathode is printed, is the separator.

### TECHNICAL FIELD

This disclosure relates to a method of producing a metal-air button cell having an air cathode and a metal-based anode, and metal-air button cells produced according to the method.

### BACKGROUND

Metal-air button cells typically include a metal-based anode and an air cathode for electrochemically active components, separated one from the other by an ion conducting electrolyte. During discharge, oxygen is reduced on the air cathode accompanied by electron acceptance. Hydroxide ions are produced and can migrate to the anode via the electrolyte. On the anode, a metal is oxidized accompanied by electron donation. The metal ions obtained react with the hydroxide ions.

There are both primary and secondary metal-air cells established. A secondary metal-air cell is recharged in that a voltage is applied between anode and cathode, and the electrochemical reaction described above is reversed. Thereby, oxygen is released.

The most common example of a metal-air cell is the zinc-air cell. In the form of a button cell it is employed in particular for batteries in hearing aid applications.

Metal-air cells exhibit a comparatively high energy density since the need for oxygen on the cathode can be satisfied by atmospheric oxygen in the environment. Accordingly, there is a need to supply atmospheric oxygen to the cathode during a discharging procedure. In contrast, oxygen produced on the air cathode during a charging procedure of a metal-air cell has to be drained. For that purpose, metal-air cells generally have housings, wherein respective input and output apertures are provided. In general, holes are punched into the housings to provide the input and output apertures, respectively, for example, in the bottom of a button cell housing. Within the housing, there is fine distribution of the introduced atmospheric oxygen typically by using appropriate membranes or filters.

In metal-air cells, gas diffusion electrodes are typically employed as an air cathode. Gas diffusion electrodes are electrodes, wherein the reagents involved in the electrochemical reaction (in general a catalyst, an electrolyte and atmospheric oxygen) are present coexistently in solid, liquid and gaseous state, and capable of contacting with each other. The catalyst is to catalyze reduction of the atmospheric oxygen during discharging and optionally also oxidation of hydroxide ions during charging of the cells.

Plastic bonded gas diffusion electrodes are most commonly used as air cathodes in metal-air cells. Such gas diffusion electrodes are described in DE 37 22 019 A1, for example. In such electrodes, a plastic binder (mostly polytetrafluoroethylene, PTFE) constitutes a porous matrix, wherein particles made of an electro-catalytically active material (a noble metal, like platinum or palladium, or manganese oxide, for example) are incorporated. The particles have to be capable of catalyzing the above mentioned reaction of atmospheric oxygen. Production of such electrodes is effected in general in that a dry mixture composed of binder and catalyst is rolled out to a film. The film in turn can be rolled in a metal mesh, for example, made of silver, nickel, or silver-plated nickel. The metal mesh is a conductor structure within the electrode and serves as a current conductor.

Batteries are producible not only by assembly of solid distinct components, in fact, in recent years, increasing importance is given to batteries produced using at least some functional parts, in particular electrodes and/or required circuit tracks, prepared by printing, that is, using a solvent and/or suspension agent based paste. In general, printed batteries have a multi-layered structure. In conventional structural design, a printed battery typically comprises two current collector planes, two electrode planes and one separator plane in a stacked arrangement. Therein, the separator plane is interposed between the two electrode planes, while the current collectors constitute the top and bottom side, respectively, of the battery. A battery exhibiting such a design is described in U.S. Pat. No. 4,119,770, for example.

Significantly thinner batteries, wherein the electrodes are arranged side-by-side on a planar, electrically non-conducting substrate, are disclosed in WO 2006/105966. The electrodes are interconnected via an ion conducting electrolyte, wherein the electrolyte may be a gel-type zinc chloride paste, for example. In general, the electrolyte therein is reinforced and stabilized by a nonwoven or mesh type material.

To date, there are only printed batteries including solid electrodes. For example, these electrodes on the cathode side are manganese oxide electrodes in aqueous systems and electrodes made of lithium cobalt oxide or lithium iron phosphate in organic electrolyte systems. Batteries, wherein printed functional parts are combined with a gas diffusion electrode, are not disclosed to date.

It could therefore be helpful to provide button cells characterized by a particularly high capacity and are simple to manufacture.

### SUMMARY

We provide a method of producing a metal-air button cell including a housing, an air cathode, a metal-based anode and a separator arranged in the housing, the method including printing the air cathode in the form of a planar layer onto a planar substrate by a screen printing process, wherein a paste including a solvent and/or suspending agent, particles made of an electro-catalytically active material, and binder particles made of a hydrophobic plastic material is used for printing, and inserting the laminar composite structure obtained during printing and which includes the planar substrate and the air cathode applied thereto into the housing and combined with the metal-based anode, wherein the planar substrate, onto which the air cathode is printed, is the separator.

We also provide a method of producing a metal-air button cell including a housing, an air cathode, a metal-based anode and an air permeable, planar substrate made of a microporous material arranged in the housing, the method including printing the air cathode in the form of a planar layer onto a planar substrate by a screen printing process, wherein a paste including a solvent and/or suspending agent, particles made of an electro-catalytically active material, and binder particles made of a hydrophobic plastic material is used for printing, and inseting the laminar composite structure obtained during printing and which includes the planar substrate and the air cathode applied thereto into the housing and combined with the metal-based anode, wherein the planar substrate, onto which the air cathode is printed, is the planar substrate made of the microporous material.

We further provide a method of producing a metal-air button cell having an air cathode and a metal-based anode, wherein the air cathode is applied in the form of a planar layer to a planar substrate by a screen printing process, and the laminar composite structure obtained during printing and includes the planar substrate and the air cathode applied thereto, is inserted into a button cell housing and combined with the metal-based hands.

We further still provide a metal-air button cell including a one-pied laminar composite structure comprising a planar substrate and an air cathode applied thereon.

### BRIEF DESCRIPTION OF THE DRAWINGS

In FIGS. 1-9, cross sectional views of (1) to (9) of a laminar composite structure including a planar substrate and an air cathode applied thereto are illustrated diagrammatically.

FIG. 1 shows a laminar composite structure of the sequence: air permeable, planar substrate 2-air cathode 1.

FIG. 2 shows a laminar composite structure of the sequence: air permeable, planar substrate 2-conductor structure 3-air cathode 1.

FIG. 3 shows a laminar composite structure of the sequence: air permeable, planar substrate 2-air cathode 1-conductor structure 3.

FIG. 4 shows a laminar composite structure of the sequence: air permeable, planar substrate 2-conductor structure 3-air cathode 1-conductor structure 3.

FIG. 5 shows a laminar composite structure of the sequence: air permeable, planar substrate 2-conductor structure 3-air cathode 1-conductor structure 3-separator 4.

FIG. 6 shows a laminar composite structure of the sequence: conductor structure 3-air cathode 1-conductor structure 3-separator 4.

FIG. 7 shows a laminar composite structure of the sequence: air cathode 1-conductor structure 3-separator 4.

FIG. 8 shows a laminar composite structure of the sequence: conductor structure 3-air cathode 1-separator 4.

FIG. 9 shows a laminar composite structure of the sequence: air cathode 1-separator 4.

FIG. 10 shows a diagrammatic cross sectional view of an example of a metal-air button cell 100.

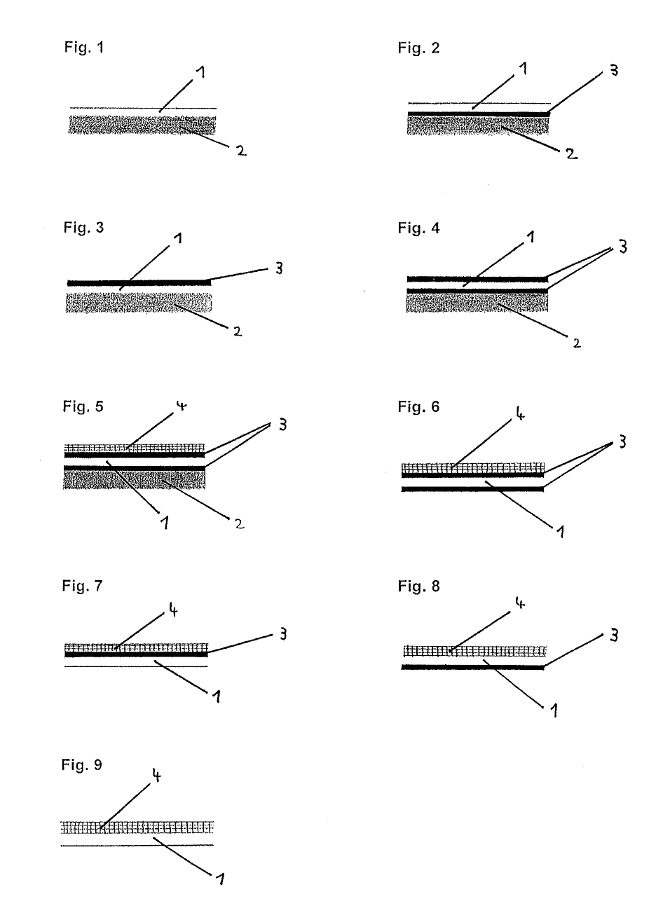

### DETAILED DESCRIPTION

We provide methods of producing button cells, wherein the cells comprise plastic bonded gas diffusion electrodes of the above described functionality as an air cathode. Similarly, the gas diffusion electrodes comprise a porous plastic matrix, in which particles made of an electro-catalytically active material (in short: catalyst particles) are incorporated. In particular, gas diffusion electrodes produced according to the method are suited as air cathodes in metal-air cells.

The methods are in particular characterized in that the air cathode is produced by a printing process. Preferably, the cathode is applied in the form of a planar (two-dimensional) layer onto a planar layer substrate. The laminar composite structure produced by printing, which comprises the planar substrate and the air cathode applied thereon, is subsequently inserted into a button cell housing and combined with a metal-based anode.

A printing process means, in general, a procedure wherein a paste, a solid-liquid mixture, is applied onto a substrate.

Preferably, a separator, in particular a separator film, as commonly used in button cells, is used as the substrate. In particular, a microporous plastic film or a nonwoven or felt based separator may be used. Appropriate separator materials are well-known.

In this instance, a laminar composite structure is obtained during printing of the air cathode, which composite combines both the function of a separator and of an air cathode. Thus, when producing button cells using such a laminar composite structure, one assembly step (either introduction of the air cathode or introduction of the separator) can be omitted.

It is preferred that, prior to application of the air cathode, a preferably mesh-type or grid-type conductor structure is applied onto the separator. As an alternative or in addition, such a conductor structure can also be applied onto an air cathode which has been printed onto a separator.

The conductor structure is in general composed of circuit tracks and serves predominantly as a current collector. Such circuit tracks can be implemented in various ways and manners. One option is to use electrically conductive films, in particular metal films, for circuit tracks. Even the use of a mesh or a grid made of metal, for example, nickel, silver or silver-plated nickel, is possible. Another option is to use thin metal layers for circuit tracks which are applicable to a substrate by a conventional metallization method (e.g., deposition from the gas phase or vapor deposition). Finally, the circuit tracks can of course also be printed on, for example, by using a paste including silver particles.

Preferably, the substrate may be an air permeable, planar substrate made of microporous material, like a nonwoven, paper, felt, or of a microporous plastic.

Such substrates are commonly used in membranes or filters within the housings of button cells for fine distribution of atmospheric oxygen entering into the housing. Appropriate microporous substrates are well-known.

In this instance, a laminar composite structure is obtained during printing of the air cathode, which composite combines both the function of a means for fine distribution of atmospheric oxygen entering into the housing and also of an air cathode. Thus, when producing button cells using such a laminar composite structure, one assembly step (either introduction of the air cathode or introduction of such a means for fine distribution) can be omitted.

If such a composite including the air cathode is not employed, it is preferred that a nonwoven, paper, felt, or a microporous plastic film is used as a separate component.

Preferably, prior to application of the air cathode, a preferably mesh-type or grid-type conductor structure is applied to the air permeable, planar substrate made of microporous material. As an alternative or in addition, such a conductor structure can also be applied to the air cathode that has been printed onto the substrate.

Particularly preferably, a separator in the form of a planar layer may be printed onto an air cathode that has been printed onto the air permeable, planar substrate made of the microporous material, or optionally onto a, preferably mesh-type or grid-type, conductor structure present on the cathode. Thereby, a laminar composite structure is obtained which combines both the functions of a means for fine distribution of the atmospheric oxygen entering into the housing and also of an air cathode and of a separator. Thus, two assembly steps can be omitted during the production of button cells using such a laminar composite structure.

When a preferably mesh-type or grid-type conductor structure is not applied to, it is preferred that a conductor is inserted as a separate component, in particular in the form of a mesh or grid, in the housing of the button cells to be produced.

When the separator is not employed in printed form or as a composite with the air cathode, it is preferred that the separator is inserted as a separate component, in particular in the form of a separator film, in the button cell to be produced.

Surprisingly, we found that operative air cathodes can readily be printed using a paste comprising a solvent and/or suspending agent, particles made of an electro-catalytically active material (catalyst particles), and particles made of a hydrophobic plastic material (the porous plastic matrix is made of). As discussed above, production of plastic bonded gas diffusion electrodes is traditionally effected by pressing of dry mixtures composed of a plastic binder and a catalyst. That operative air cathodes can also be produced using a comparatively simple printing process using a solvent and/or suspending agent based paste, was not to be expected a priori.

The mentioned printing process is particularly preferably a screen printing process. Screen printing is a printing procedure, wherein printing pastes are pressed through a fine-meshed fabric by a blade onto the material to be printed. On those locations of the fabric, where according to the print image paste should not be printed on, the mesh apertures of the fabric are made impermeable by a printing screen. On the other locations, however, the printing paste should be able to penetrate the mesh apertures unhindered. To prevent the occurrence of plugging of the mesh apertures, the solid constituents included in the printing paste should not exceed a certain maximum size, which should be less than the mesh aperture width.

The particles in pastes employed preferably include in particular a mean diameter of 1 μm to 50 μm. Preferably the pastes do not include particles having a diameter and/or a length of more than 120 μm, particularly preferred more than 80 μm. These preferred size ranges apply both to the particles made of hydrophobic plastic material and to those made of electro-catalytically active material.

The solvent and/or suspending agent is preferably a polar solvent, in particular water. Optionally, water-alcohol mixtures may be employed. In general, the solvent and the suspending agent, respectively, is removed after applying the paste. To that end, the agent can simply be allowed to evaporate at ambient (room) temperature. Of course, another option is to actively support evaporation such as by increased temperature or application of low pressure.

The particles made of electro-catalytically active material are preferably the above mentioned catalyst materials, that is, in particular particles made of a noble metal, like palladium, platinum, silver or gold, and/or manganese oxide. In relation to utile manganese oxides, reference is made in particular to the above mentioned DE 37 22 019 A1, and the entire contents thereof are incorporated herein by reference.

The particles made of hydrophobic plastic material are preferably particles made of fluoropolymer. A particularly preferred fluoropolymer is PTFE, as mentioned above. Due to chemical resistance and hydrophobic characteristics, PTFE is particularly useful. In admixture with the rather hydrophilic electro-catalytically active particles, PTFE provides an electrode structure including both hydrophilic and hydrophobic zones. Both aqueous electrolyte and air are capable of penetrating into such a structure. Thus, the above mentioned aggregation states can be coexisting in the electrode. That production of such porous structures is feasible without hot pressing or sintering procedures, is very surprising.

The paste used in our methods preferably includes at least one conductivity enhancing additive, in particular a particulate conductivity enhancing additive. The additive can in particular be selected from the group consisting of carbon nanotubes (CNTs), carbon black, and metal particles (made of nickel, for example).

The particles preferably have sizes in the ranges as indicated above with reference to the particles made of hydrophobic plastic material and made of electro-catalytically active material.

Furthermore, the paste may include one or more further additives, in particular for adjustment of processing characteristics of the paste. Accordingly, as a basic principle, all additives adapted to be used in print pastes can be employed as additives, for example, rheology auxiliaries to adjust viscosity of the paste.

Preferably, the paste includes a proportion of solvent and/or suspending agent of 20% by weight to 50% by weight. In other words, the solids content of the paste is 50% by weight to 80% by weight.

Particularly preferred is that the paste includes the following constituents in the following proportions:
20% by weight to 50% by weight of the solvent and/or suspending agent,
0% by weight to 20% by weight of the particles made of electro-catalytically active material,
0.5% by weight to 5% by weight of the binder particles made of hydrophobic plastic material, and
30% by weight to 80% by weight of the at least one conductivity enhancing additive.

The percentages of the mentioned ingredients preferably add up to 100% by weight.

That separators can be produced by printing is disclosed in DE 10 2010 018 071 A1, and the entire contents thereof are incorporated herein by reference. DE '071 proposes a separator printing paste to print of separators, with the paste comprising a solvent, at least one conducting salt dissolved in the solvent, and particles and/or fibers which are at least nearly, preferably completely, insoluble in the solvent at ambient temperature and also electrically non-conducting. Surprisingly we observed that separators made of a microporous film or a nonwoven, for example, can readily be substituted as to functionality by an electrolyte layer producible using such a separator printing paste, wherein the above particles and/or fibers are included.

Particles and/or fibers included in the separator printing paste can form a three-dimensional matrix during the printing process, and thus impart a solid structure and sufficiently high mechanical strength to the resulting separator to prevent contact between electrodes of opposite polarity. A prerequisite condition is, as already mentioned, that the particles and/or fibers are not electrically conducting. Furthermore, the particles and/or fibers should have chemical resistance in the presence of the solution composed of the at least one conducting salt and the solvent, in particular be not soluble or only to a very small extent soluble in the solvent, at least at ambient temperature. Preferably, the particles and/or fibers are included in the separator printing paste in a proportion of 1% by weight to 75% by weight, in particular 10% by weight to 50% by weight. In that context it is not relevant, whether there are exclusively particles or fibers employed, or even a mixture of particles and fibers is employed.

The particles and/or fibers are preferred to have an average diameter and in case of the fibers, respectively, an average length of 1 μm to 50 μm. Particularly preferred is that the separator printing paste is free of any particles and/or fibers having a diameter and/or length of more than 120 μm. In the ideal case, the maximum diameter and/or the maximum length of the particles and/or fibers contained in the separator printing paste is 80 μm. The relevant context is that the separator printing paste is in particular as well intended for processing procedures using a screen printing process.

The particles and/or fibers in the separator printing paste may in principle be composed of most differing materials, as long as the above mentioned prerequisite conditions are satisfied (electrically non-conducting characteristics, insolubility in and chemical resistance towards the conducting salt solution). Accordingly, the particles and/or fibers can be composed of both an organic and also of an inorganic solid material. There is an option, for example, to admix fibers made of organic materials to particles made of inorganic materials, or vice versa.

Particularly preferred is that the inorganic solid comprises at least one constituent selected from the group consisting of ceramic solid materials, salts that are almost or completely insoluble in water, glass, basalt or carbon. The phrase “ceramic solid materials” comprises all those solid materials that are useful to produce ceramic products, among them silicate materials, like aluminum silicates, glasses, and clay minerals, oxide raw materials, like titanium dioxide and aluminum oxide, and non-oxide materials, like silicon carbide or silicon nitride.

The organic solid material preferably has at least one constituent selected from the group consisting of synthetic polymer materials, semisynthetic polymer materials, and natural materials.

The phrase “almost or completely insoluble at ambient temperature” indicates that at room temperature in a corresponding solvent an at most minor solubility, preferably no solubility at all, is observed. The solubility of particles and/or fibers in particular solubility of the salts that are in water almost or completely insoluble, should in the ideal case not exceed the solubility of calcium carbonate in water at ambient temperature (25° C.). Incidentally, calcium carbonate is a particularly preferred example for an inorganic solid material that may be included in a separator printing paste as a constituent having a spacer function, in particular in the form of particles.

The phrase “fiber” is to be given a broad interpretation. In particular elongate products should be covered thereby that are very thin as compared to the length thereof. For example, fibers made of synthetic polymers, like polyamide fibers or polypropylene fibers, for example, are well adapted to be employed. As an alternative, fibers of inorganic or organic origin, like glass fibers, ceramic fibers, carbon fibers, or cellulose fibers, for example, may be employed.

The solvent in the separator printing paste is preferably a polar solvent, for example, water. However, in general, even non-aqueous aprotic solvents can be used, like those well-known in the field of lithium-ion batteries.

The conducting salt in the separator printing paste is preferably at least one compound soluble in the solvent contained in the printing paste at ambient temperature, and is present therein in the form of solvated ions, respectively. The conducting salt preferably comprises at least one constituent selected from the group consisting of zinc chloride, potassium hydroxide, and sodium hydroxide. Furthermore, there are optionally even other conducting salts, like lithium tetrafluoroborate, which are also well-known in particular in the field of lithium-ion batteries, useful as conducting salts.

In addition to conducting salts, a solvent and the particles and/or fibers, as described, the separator printing paste can additionally comprise a binder and/or one or more additives. While the binder is in particular included to impart an improved mechanical resistance, in the ideal case an improved mechanical strength and flexibility, to the separator produced using the separator printing paste, the additives are included in particular to vary processing characteristics of the separator printing paste. Accordingly, in general, all additives adapted to be used in printing pastes are utile to be employed as additives, for example, rheology auxiliaries to adjust viscosity of the separator printing paste. The binder can be an organic binder, like carboxymethyl cellulose, for example. Other constituents are also utile as additives exhibiting binding characteristics, optionally even inorganic constituents, like silicon dioxide.

Preferably, the separator is printed to a thickness of 10 μm to 500 μm, in particular 10 μm to 100 μm. In this range, the separator has sufficient separating characteristics, to prevent a short circuit between electrodes of opposite polarity.

The housing of a button cell is in general composed of a cell cup, a cell lid, and a sealing interposed there between. With metal-air cells, in general, the bottom of the cell cup has inlet openings and outlet openings, respectively, for oxygen, as mentioned above. In a conventional manufacturing variant for production of metal-air cells, a filter paper (or as an alternative the above mentioned microporous film or nonwoven) is placed in a bowl-shaped cell cup to cover the bottom of the cup and the inlet and outlet openings, respectively, punched therein. The filter paper finely distributes atmospheric oxygen entering via the openings in the interior of the cell.

During production of conventional button cells, a porous air cathode made by compressing a dry mixture (like the one disclosed in DE 37 22 019, for example) is subsequently placed onto the filter paper, to allow reduction of atmospheric oxygen at the cathode. The cathode in turn is covered by a planar (two-dimensional) separator, with the separator forming a boundary layer between anode and cathode space within the cell. A cup pre-assembled such is in general combined with a bowl-shaped cell lid, wherein the lid is filled with zinc powder as an anode material and electrolyte, for example, and wherein a ring-shaped plastic seal is applied to the exterior side of the cell lid. The cell lid is inserted into the cell cup such that the plastic seal is located between the two housing parts. By flanging the terminal edge of the cell cup over the inserted cell lid, the cell can be closed to be liquid-tight.

To produce button cells, the mentioned laminar composite structures composed of the described substrate and the air cathode printed thereon are used. To that purpose, segments, in particular circular or oval segments, can be cut from the respective laminar composite structure (by punching, e.g.), and placed in a button cell housing, similar to those used conventionally. Contingent upon the laminar composite structure used, as mentioned above, the conventionally used separator or the means for fine distribution of atmospheric oxygen can be omitted, as the case may be.

Since printed air cathodes in the form of very thin layers can be produced, the result can be a great saving in space within the cell. This applies even in case that the fine distribution of atmospheric oxygen and/or an additional separator cannot be omitted. As a consequence, more active material can be introduced into the cell, and the cell has an accordingly increased capacitance.

Appropriate anodes adapted to be combined to the laminar composite structure in the button cell housing, are in general known to a person. Particularly preferred is the use of zinc-based anodes.

Metal-air button cells produced or producible using our methods are also possible. Such metal-air button cells preferably have an integral laminar composite structure comprising a planar substrate and an air cathode applied to the substrate. Preferably, the laminar composite structure includes one of the following layer sequences:
(1) air permeable, planar substrate-air cathode;
(2) air permeable, planar substrate-conductor structure-air cathode;
(3) air permeable, planar substrate-air cathode-conductor structure;
(4) air permeable, planar substrate-conductor structure-air cathode-conductor structure;
(5) air permeable, planar substrate-conductor structure-air cathode-conductor structure-separator;
(6) conductor structure-air cathode-conductor structure-separator;
(7) air cathode-conductor structure-separator;
(8) conductor structure-air cathode-separator;
(9) air cathode-separator.

Preferably, the laminar composite structures have a thickness of 60 μm to 300 μm.

The metal-air button cells are particularly preferred zinc-air button cells, that is, cells including a zinc-based anode.

Further features will become apparent from the following description of preferred examples. Hereby, explicit reference is made to the fact that all facultative aspects of the methods or products as described herein can in each case be implemented on their own or in combination with one or more of further described facultative aspects in an examples. The following description of preferred examples is merely for illustration and better understanding, and is in no way to be interpreted as limiting.

### EXAMPLES

### (1) Production of a Laminar Composite Structure of the Sequence “Substrate-Conductor Structure-Air Cathode”

A mesh-type structure of current conductors (the conductor structure) was printed onto a microporous film (the substrate) made of polytetrafluoroethylene (PTFE, Teflon) using a silver paste. Onto the structure, an air cathode was printed by a screen printing procedure. The paste used for the air cathode was composed of a mixture including 5 parts by weight of PTFE particles (particles made of electro-catalytically active material) having an average particle size of 10 μm, 10 parts by weight of manganese oxide particles (particles made of electro-catalytically active material) having an average particle size of 20 μm, and 50 parts by weight of activated carbon (conductivity enhancing additive) having an average particle size of 50 μm. The liquid constituent included in the paste was 35 parts by weight of water (solvent and/or suspending agent).

The air cathode was printed to a layer thickness of ca. 100 μm on the PTFE film. After removing the solvent and the suspending agent, respectively, the layer thickness of the obtained planar air cathode on the film was ca. 50 μm. The obtained laminar composite structure including the sequence “substrate-conductor structure-air cathode” had a total thickness of ca. 150 μm.

### (2) Production of a Laminar Composite Structure of the Sequence “Substrate-Conductor Structure-Air Cathode-Separator”

A separator was printed onto the laminar composite structure produced according to (1). Therefor, 77.8 parts by weight of a 50% zinc chloride solution including 3.4 parts by weight of amorphous silicon dioxide and 18.8 parts by weight of a calcium carbonate powder were admixed. The dissolved zinc chloride should ensure the required ion conductivity of the electrolyte in the battery to be produced. The employed calcium carbonate powder was composed of ca. 50% of a powder having an average grain size of less than 11 μm, and another 50% of a powder having an average grain size of less than 23 μm. Thus, the powder had a bimodal distribution. The silicon dioxide was in particular used to adjust viscosity of the paste.

Such a paste was used to print onto the air cathode. The obtained electrolyte and separator layer, respectively, had a thickness of ca. 50 μm.

### (3) Production of a Zinc-Air Button Cell

The laminar composite structures produced according to (1) and (2) can be used to manufacture button cells. Thereby, circular or oval segments, for example, are punched from the laminar composite structures and placed into a prepared cell cup, wherein the bottom of the cell cup has inlet and outlet openings, respectively, for oxygen. When using a laminar composite structure manufactured according to (1), the composite needs to be covered by a separator. When using a laminar composite structure manufactured according to (2), this step can be omitted.

Subsequently, the cell cup with the laminar composite structure and optionally the separator located therein is combined with a cell lid filled with anode material and electrolyte.

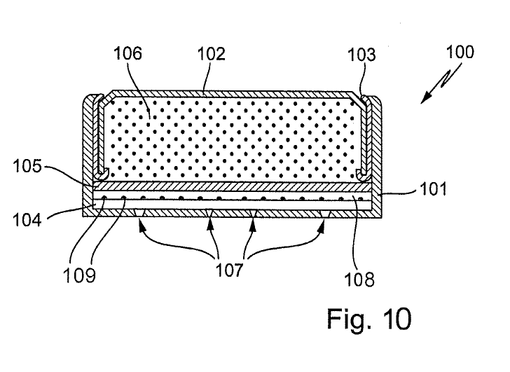

A metal-air button cell produced using a laminar composite structure manufactured according to (2) is illustrated in FIG. 10. The cell has a housing composed of a cell cup 101 and a cell lid 102. Interposed between these components is a sealing 103 to insulate the cell lid 102 relative to the cell cup 101. The bottom of the cell cup 101 has a plurality of entrance openings 107 to allow inflow of air, in particular atmospheric oxygen, into the housing.

The laminar composite structure manufactured according to (2) comprises an air permeable, planar substrate 104. The substrate 104 could be, as described above, a filter paper or a nonwoven, for example. A mesh-type conductor structure 109 is deposited on the substrate 104, and the structure 109 again is printed over using the described paste including the PTFE particles and the manganese oxide particles to obtain an air cathode layer 108. Finally, the laminar composite structure also comprises a separator layer 105. This layer 105 separates the air cathode 108 from the anode 106 which is made of a zinc-based paste, for example.

1-13. (canceled)

14. A method of producing a metal-air button cell comprising a housing, an air cathode, a metal-based anode and a separator arranged in the housing, the method comprising:
printing the air cathode in the form of a planar layer onto a planar substrate by a screen printing process, wherein a paste comprising a solvent and/or suspending agent, particles made of an electro-catalytically active material, and binder particles made of a hydrophobic plastic material is used for printing, and
inserting the laminar composite structure obtained during printing and which comprises the planar substrate and the air cathode applied thereto, into the housing and combined with the metal-based anode,
wherein the planar substrate, onto which the air cathode is printed, is the separator.

15. A method of producing a metal-air button cell comprising a housing, an air cathode, a metal-based anode and an air permeable, planar substrate made of a microporous material arranged in the housing, the method comprising:
printing the air cathode in the form of a planar layer onto a planar substrate by a screen printing process, wherein a paste comprising a solvent and/or suspending agent, particles made of an electro-catalytically active material, and binder particles made of a hydrophobic plastic material is used for printing, and
inserting the laminar composite structure obtained during printing and which comprises the planar substrate and the air cathode applied thereto, into the housing and is combined with the metal-based anode,
wherein the planar substrate, onto which the air cathode is printed, is the planar substrate made of the microporous material.

16. A method of producing a metal-air button cell having an air cathode and a metal-based anode, wherein the air cathode is applied in the form of a planar layer to a planar substrate by a screen printing process, and the laminar composite structure obtained during printing and comprises the planar substrate and the air cathode applied thereto, is inserted into a button cell housing and combined with the metal-based anode.

17. The method according to claim 16, wherein a separator film is the substrate.

18. The method according to claim 17, wherein
prior to applying the air cathode, a mesh-type or grid-type conductor structure is printed onto the separator, and/or
a mesh-type or grid-type conductor structure, after applying the air cathode, is printed onto the air cathode.

19. The method according to claim 16, wherein an air permeable, planar substrate made of a microporous material is used for a substrate.

20. The method according to claim 19, wherein
prior to applying the air cathode, a mesh-type or grid-type conductor structure printed onto the air permeable, planar substrate, and/or
a mesh-type or grid-type conductor structure, after applying the air cathode, is printed onto the air cathode.

21. The method according to claim 16, wherein a separator in the form of a planar layer is printed onto the air cathode or, optionally, onto the mesh-type or grid-type conductor structure.

22. The method according to claim 16, wherein the air cathode is printed using a paste comprising a solvent and/or suspending agent, particles made of an electro-catalytically active material, and binder particles made of a hydrophobic plastic material.

23. The method according to claim 22, wherein the solvent and/or suspending agent is water.

24. The method according to claim 22, wherein the particles made of the electro-catalytically active material are particles made of a noble metal and/or manganese oxide.

25. The method according to claim 22, wherein the particles made of the hydrophobic plastic are particles made of polytetrafluoroethylene.

26. A metal-air button cell comprising a one-piece laminar composite structure comprising a planar substrate and an air cathode applied thereon.

27. The metal-air button cell according to claim 26, wherein the one-piece laminar composite structure includes one of the following layer sequences:
(1) air permeable, planar substrate-air cathode;
(2) air permeable, planar substrate-conductor structure-air cathode;
(3) air permeable, planar substrate-air cathode-conductor structure;
(4) air permeable, planar substrate-conductor structure-air cathode-conductor structure;
(5) air permeable, planar substrate-conductor structure-air cathode-conductor structure-separator;
(6) conductor structure-air cathode-conductor structure-separator;
(7) air cathode-conductor structure-separator;
(8) conductor structure-air cathode-separator;
(9) air cathode-separator.
